(19) United States
(12) Patent Application Publication
(10) Pub. No.: US 2013/0056442 A1
(43) Pub. Date: Mar. 7, 2013

(54) OPTICAL WAVEGUIDE FABRICATION METHOD

(71) Applicants: Bing Li, Shanghai (CN); Xiaogang Li, Shanghai (CN); Zhehui Wang, Shanghai (CN)

(72) Inventors: Bing Li, Shanghai (CN); Xiaogang Li, Shanghai (CN); Zhehui Wang, Shanghai (CN)

(21) Appl. No.: 13/639,823

(22) PCT Filed: Apr. 29, 2011
(86) PCT No.: PCT/CN11/73563

§ 371 Date: Nov. 8, 2012

(30) Foreign Application Priority Data
Apr. 29, 2010 (CN) 201010159801.4

(51) Int. Cl. B05D 5/06; B44C 1/22; B05D 3/10

(52) U.S. Cl. 216/24; 427/163.2

(57) ABSTRACT

The present invention relates to a method of manufacturing optical waveguide devices. The order of patterning/etch in the method is first a deeper etching then shallow etching. In some embodiments, the first etching forms a mesa and the second etching removes a portion of material that comprises the mesa. In addition, there can be a planarization step. The deeper trenches are desirably conducive to filling. The method may use a cross-lithography method to reduce alignment errors between multiple patterning/etching steps. The method may use an oxidation and stripping off process to smooth a surface of the waveguide and/or reduce an initial dimension of the waveguide.

### CROSS-REFERENCE TO RELATED APPLICATIONS

This patent application claims the benefit of PCT Application No. PCT/CN2011/073563, filed on Apr. 29, 2011, which claims priority to Chinese Patent Application No. 201010159801.4, filed on Apr. 29, 2010, the entire contents of each are hereby incorporated herein by reference.

### BACKGROUND OF THE INVENTION

This invention relates to a method of manufacturing optical waveguide devices.

Optical waveguides are known in the art and can be used in planar light circuits (PLC). For example, silicon rib waveguides can be formed on Silicon-On-Insulator (SOI) wafers. Some examples of waveguide devices and manufacturing methods are described in U.S. Pat. No. 5,078,516, U.S. Pat. No. 7,016,587, U.S. Pat. No. 7,499,620, U.S. Pat. No. 7,539,373, US 2009/0252456 and US 2010/0055906, the entire disclosures of which are hereby incorporated herein by reference.

Silicon rib or ridge waveguides can be manufactured using multiple lithographic processes and etching steps. In these processes, the order of multiple etching steps is generally performed sequentially—first on higher/top layer(s), then on lower layer(s). Thus, existing processes generally perform a shallow etching step first, followed by a deeper etching step. Such etching steps are often performed on a non-planar wafer surface.

When using multiple etching steps, any error or offset alignment in the sequential lithography and etching steps will seriously affect the optical properties of the silicon rib planar optical waveguides.

Meanwhile, the etching steps may make the silicon wafer surface have various states of surface roughness. A rough surface may increase optical scattering losses.

There remains a need for patterning processes having multiple etching steps wherein the potential for offset alignment errors between the multiple etching steps is reduced.

All U.S. patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R. 1.72. The abstract is not intended to be used for interpreting the scope of the claims.

### BRIEF SUMMARY OF THE INVENTION

In at least one embodiment, a method of making an optical waveguide comprises providing a silicon wafer and patterning a surface of the silicon wafer to form a silicon mesa. A surface of the silicon mesa is then patterned to form a silicon ridge. In some embodiments, a portion of the silicon ridge comprises a taper.

In at least one embodiment, a method of making an optical waveguide comprises providing a silicon wafer and patterning a top surface of the silicon wafer to remove a first portion of material to a first predetermined depth. A remaining portion of the top surface is then patterned to remove a second portion of material to a second predetermined depth, wherein the first predetermined depth is deeper than the second predetermined depth.

In some embodiments, after a patterning step, the wafer is planarized.

In some embodiments, a patterning mask used in the first patterning process is shaped differently from a patterning mask used in the second patterning process, wherein the different masks are cross-aligned to reduce alignment errors between the multiple patterning steps.

In some embodiments, the surface planarization process may have a step of depositing a material on the upper surface of the wafer and filling in any trenches with a filler material. The silicon wafer can then be planarized using chemical-mechanical planarization or an etch-back method. In some embodiments, a filler material may be an anti-reflective coating, poly-silicon or silicon oxide.

In some embodiments, when the filler material is an anti-reflective coating, the anti-reflective coating and any photoresist from a patterning process may be removed together.

In some embodiments, when the filler material is silicon oxide or poly-silicon, the filler material can remain in trenches or be removed, for example by corrosion.

In some embodiments, the main component of the anti-reflective coating is hydrocarbons, which can be removed by organic solvents.

In some embodiments, after the completion of all patterning/etches, the silicon ridge is oxidized and de-oxidized (e.g. stripping off the oxidized layer), thereby reducing a critical initial width dimension of the waveguide and/or smoothing the surface of the silicon.

In some embodiments, a covering layer of low refractive index material is deposited on the surface of the waveguide. In some embodiments, the low refractive index material is silicon dioxide or silicon nitride, and the covering layer may have a single or multi-layer structure.

In at least one embodiment, a method of making an optical waveguide comprises providing a silicon wafer and patterning a surface of the silicon wafer according to a first masking pattern, which removes a first portion of material to a first predetermined depth. Desirably, trenches are formed that define a silicon mesa between the trenches. The trenches can be filled with a filler, and a top surface of the silicon wafer is planarized. A surface of the silicon mesa is patterned to remove a second portion of material according to a second masking pattern. Removal of silicon mesa material can define a leading-in portion of the mesa, which can become the ridge of an optical waveguide.

The method of fabrication described herein can be used directly in a general CMOS factory. The method of fabrication may be performed on materials including, but not limited to, SOI, silica on silicon, quartz silica, NiNbO₃, and InP wafers. The method disclosed herein desirably exhibits one or more of the following benefits: 1) alignment issues resulting from multiple patterning/etching steps can be solved by using a cross-lithography method; 2) a surface planarization step can make the surface planar and conducive to subsequent processing; 3) adding oxidation and stripping-off steps can solve rough waveguide surface problems and therefore reduce the optical scattering losses, while also reducing the critical dimensions of silicon islands.

These and other embodiments which characterize the invention are pointed out with particularity in the claims annexed hereto and forming a part hereof However, for a better understanding of the invention, its advantages and objectives obtained by its use, reference can be made to the drawings which form a further part hereof and the accompanying descriptive matter, in which there are illustrated and described various embodiments of the invention.

### BRIEF DESCRIPTION OF THE DRAWINGS

A detailed description of the invention is hereafter described with specific reference being made to the drawings.

FIG. 1 shows an example of a silicon wafer.

FIG. 2 shows an example of a silicon wafer during a first patterning step.

FIG. 3 shows an example of a silicon wafer after the first patterning step.

FIG. 4 shows a three-dimensional view of an example of a silicon wafer after the first patterning step.

FIGS. 5 and 6 shows an example of a silicon wafer during additional processing steps.

FIGS. 7 and 8 show examples of a silicon wafer during a second patterning step.

FIG. 9 shows a three-dimensional view of an example of a silicon wafer during the second patterning step.

FIG. 10 shows an example of a silicon wafer after silicon has been removed by the second patterning step.

FIG. 11 shows an example of a silicon wafer after the second patterning step.

FIG. 12 shows a top view of a mesa, and the cross-defined mask patterns that can be used in the first and second patterning steps.

FIG. 13 shows a three-dimensional view of an example of a silicon wafer after the second patterning step.

FIGS. 14 and 15 show an embodiment of a mesa during a process of oxidation and de-oxidation.

FIG. 16 shows an embodiment of a waveguide that can result from the process disclosed herein.

### DETAILED DESCRIPTION OF THE INVENTION

While this invention may be embodied in many different forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

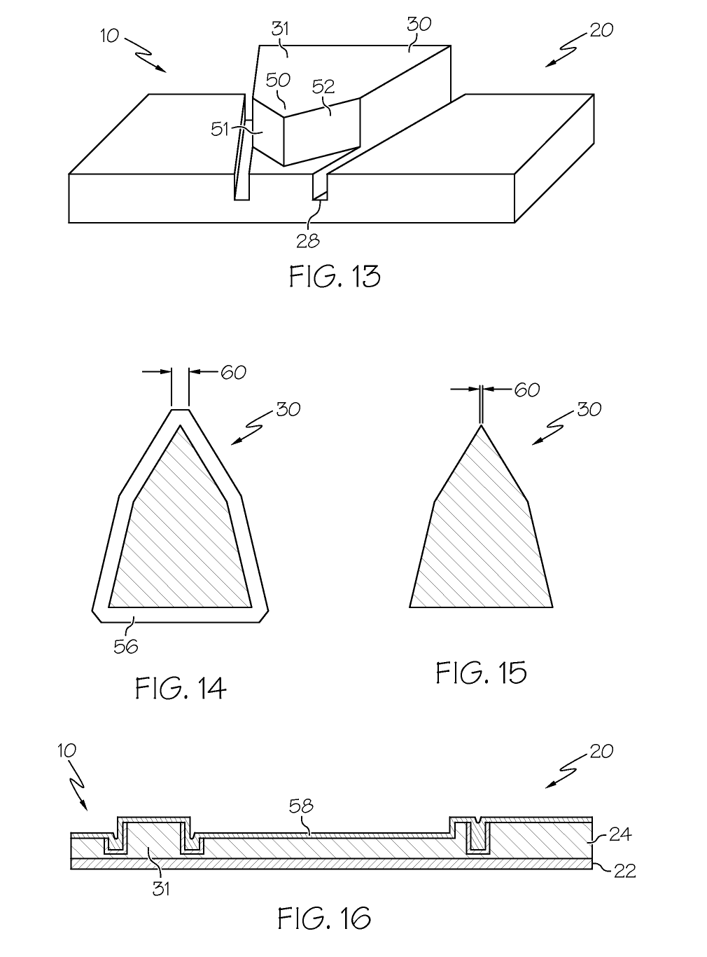

This application discloses a process for forming an optical waveguide 10 comprising a ridge 31 having a tapered leading-in portion 50, for example as illustrated in FIG. 13.

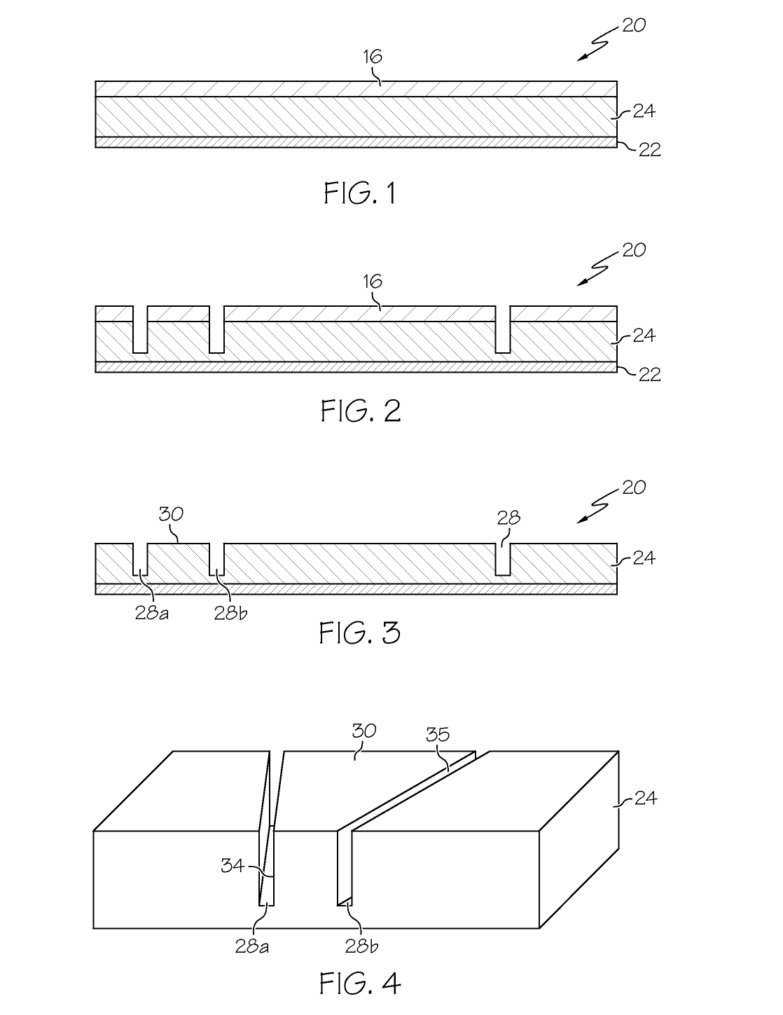

FIG. 1 shows a silicon wafer 20 that has been provided, which is suitable for forming an optical waveguide. As shown, the silicon wafer 20 comprises a Silicon-on-Insulator (SOI) wafer having a buried silicon oxide layer 22 and a top silicon layer 24.

Although the following description is generally directed to forming a waveguide using the SOI wafer, the invention can be applied to other suitable substrates such as silica on silicon, quartz silica, Lithium Niobate, Indium phosphide (InP), and the like.

In some embodiments, the silicon wafer 20 can be manufactured using any suitable method, such as depositing the top silicon layer 24 upon silicon oxide or another suitable substrate. Some examples of forming silicon-on-insulator are disclosed in U.S. Pat. No. 5,888,297; U.S. Pat. No. 5,417,180; U.S. Pat. No. 5,061,642 and U.S. Pat. No. 4,771,016, the entire disclosures of which are hereby incorporated herein by reference.

A first patterning step is performed on a surface of the silicon wafer 20 (e.g. top surface) to remove material of the top silicon layer 24. Any suitable method can be used to achieve the first patterning step, such as an etching process. FIG. 1 shows a photoresist layer 16 that can be used in an etching process. For example, a photoresist 16 can be spin coated. After exposure and development, the etch can be performed.

FIG. 2 shows an embodiment of the silicon wafer 20 after material has been removed from the top silicon layer 24 by the first patterning step. If a photoresist 16 was used in the first patterning step, it can be removed.

FIG. 3 shows an embodiment of the silicon wafer 20 after material has been removed from the top silicon layer 24 by the first patterning step, and the resulting structure of the top silicon layer 24. At least one trench 28 has been formed in the top silicon layer 24, the trench 28 having a predetermined depth.

In some embodiments, the first patterning step forms multiple trenches 28 in the top silicon layer 24. Trenches 28 can have any suitable pattern, width and depth. In some embodiments, a mesa 30 is formed in the top silicon layer 24, for example being defined between two trenches 28a, 28b. In some embodiments, trenches 28a, 28b that define a mesa 30 have the same depth. In some embodiments, the positions and patterns of the trenches 28 may be determined by a mask (e.g. photoresist layer 16) during the first patterning step.

In some embodiments, the first patterning step forms multiple trenches 28, wherein the trenches have different depths.

In some embodiments, multiple trenches 28 extend parallel to one another. In some embodiments, a first trench 28a can be non-parallel to a second trench 28b.

FIG. 4 shows a three-dimensional view of an embodiment of a top silicon layer 24, wherein two trenches 28a, 28b were formed by the first patterning step. In some embodiments, the trenches 28a, 28b are non-parallel and the mesa 30 tapers along its length. The mesa 30 comprises a first sidewall 34 and a second sidewall 35.

In some embodiments, trenches 28 formed by the first patterning step are narrow. Trenches 28 can have a depth that is greater than their width. In some embodiments, the depth of a trench 28 is twice as much as its width. In various embodiments, the depth of a trench 28 can be 3-times; 4-times; or 8-times the width, or more. The trench 28 can have any suitable depth as compared to its width. A narrower trench 28 is easier to fill completely and therefore allows for easier planarization of the silicon wafer 20.

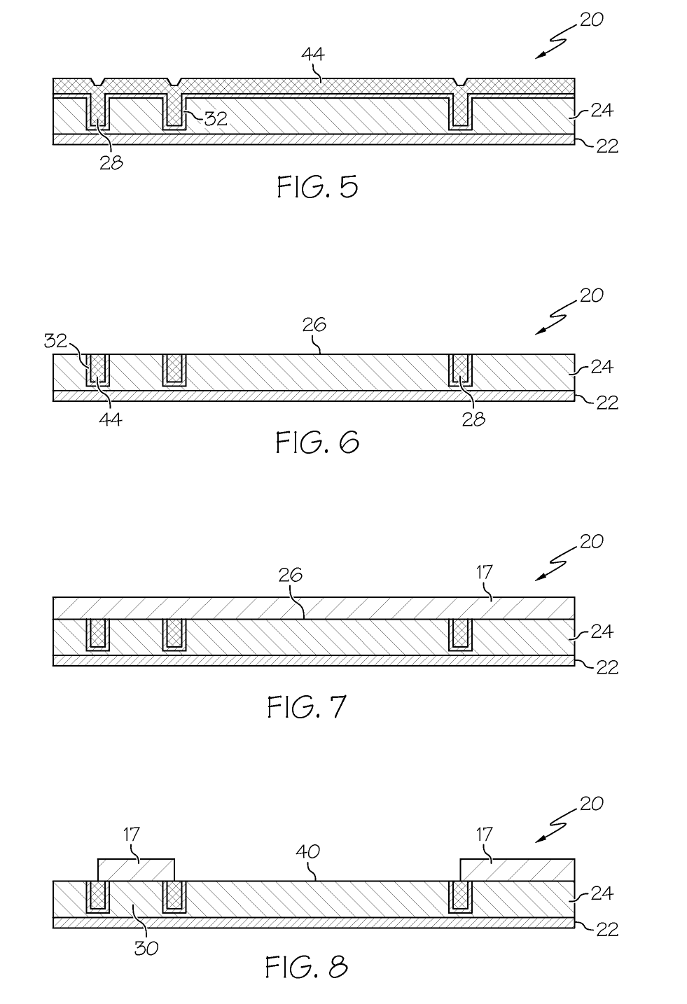

As shown in FIG. 5, in some embodiments, an optical isolation layer 32 is provided on the top silicon layer 24. An optical isolation layer 32 is optional but is desirable in some embodiments. An optical isolation layer 32 can be formed on any suitable part of the wafer 20, such as on the bottom of a trench 28, on a sidewall 34 of a mesa 30 or trench 28, and/or the top surface of a mesa 30 or non-mesa portion of the top silicon layer 24.

The optical isolation layer 32 desirably comprises a low-K material, such as an oxide film, silicon dioxide, silicon nitride, or a suitable polymeric material. An optical isolation layer 32 can be formed using any suitable method. For example, a low-κ oxide material can be formed by thermal oxidation or deposition using a vapor deposition process such as low-pressure chemical vapor deposition (LPCVD) or plasma-enhanced chemical vapor deposition (PECVD), and silicon nitride can also be deposited by LPCVD or PECVD. A polymeric optical isolation layer 32 can be added by spin-coating.

Desirably, the silicon wafer 20 is planarized prior to a second patterning step. Planarization can be accomplished using any suitable method. FIG. 5 shows an embodiment of a silicon wafer 20 during a procedure of planarization. A filler 44 can be deposited on the top silicon layer 24. The filler 44 can fill the trench(es) 28.

A narrow trench 28 is more conducive to being filled with a filler 44. For example, during a filling process, filler 44 is deposited on the various exposed surfaces of the silicon wafer 20, including the bottom and sidewalls of a trench 28. Desirably, the trench 28 can be completely filled/closed due to deposition of the filler 44 on the sidewalls of the trench 28. FIG. 5 shows the trenches 28 completely filled with the filler 44. The top surface of the filler includes some dips positioned over the trenches 28, and it can be envisioned that if the trenches 28 were wider, the dips might reach into the trench 28. Desirably, the filler 44 completely fills the trenches 28 to a height equal to or greater than the top of the top silicon layer 24. Thus, an entire cross-sectional area of each trench 28 is desirably filled. Desirably, the trenches 28 are narrow, having a small width that allows for complete filling of each trench 28. In some embodiments, the width of a trench 28 is 2 micrometers or less. In some embodiments, the width of a trench 28 is 4 micrometers or less. The specific width of a trench 28 may be selected according to the specific method of filling and the capabilities of the facility.

A filler 44 can be any suitable material and in some embodiments is an anti-reflective coating (e.g. hydrocarbons), a poly-silicon or silicon dioxide. Planarization can be achieved by any suitable method, such as a chemical mechanical planarization/polishing (CMP) method or an etch-back method (e.g. dry etch-back). An example of an etch-back method is disclosed in U.S. Pat. No. 5,814,564, the entire contents of which are hereby incorporated herein by reference. The specific filler 44 material and the shape of the trench(es) 28 desirably will not impact the CMP method. The etch-back method may be preferable in some instances, for example if a depth-to-width ratio of a trench 28 is greater than 2 (deeper/narrower trench). Generally, the greater the depth-to-width ratio, the flatter the surface of the wafer can be after planarization. Furthermore, during the etch-back process, the etching rate in the trench 28 is lower than that on the top surface, which is beneficial to retain the filler 44 inside the trench 28.

FIG. 6 shows an embodiment of the silicon wafer 20 after planarization. A top surface 26 of the silicon wafer 20 is flat. The trenches 28 still include the optional optical isolation layer 32 and the filler 44. Desirably, the top surface of the top silicon layer 24 (e.g. the non-trench portions) is free of isolation layer 32 material and free of filler 44 material.

A second patterning step is then performed on the silicon wafer 20, wherein one or more additional portions of the top silicon layer 24 are removed. In some embodiments, a portion of the mesa 30 is removed. Any suitable method can be used to achieve the second patterning step, such as an etching process.

FIG. 7 shows an embodiment of a silicon wafer 20 during a second patterning step achieved, for example, using a chemical etch. A second photoresist layer 17 is shown on the top surface 26 of the silicon wafer 20. If the trenches 28 of the silicon wafer 20 were not previously filled with a filler 44, in some embodiments, the second photoresist 17 material can fill the trenches 28. In some embodiments, the material of the second photoresist layer 17 is the same as that of the first photoresist layer 16 described above. Alternatively, the material of the second photoresist layer 17 can be different from that of the first photoresist layer 16.

FIG. 8 shows the silicon wafer 20 of FIG. 7 after exposure and development in the second patterning step. A predetermined mask pattern has been transferred to the second photoresist layer.

The second patterning step desirably removes material of the top silicon layer 24. In some embodiments, the second patterning step removes material that comprises the mesa 30, which may have been formed by the first patterning step. Thus, a portion of the mesa 30 can be removed. FIG. 8 shows a portion of the second photoresist 17 covering a portion of the mesa 30, which protects a portion of the mesa 30 that is not changed by the second patterning step.

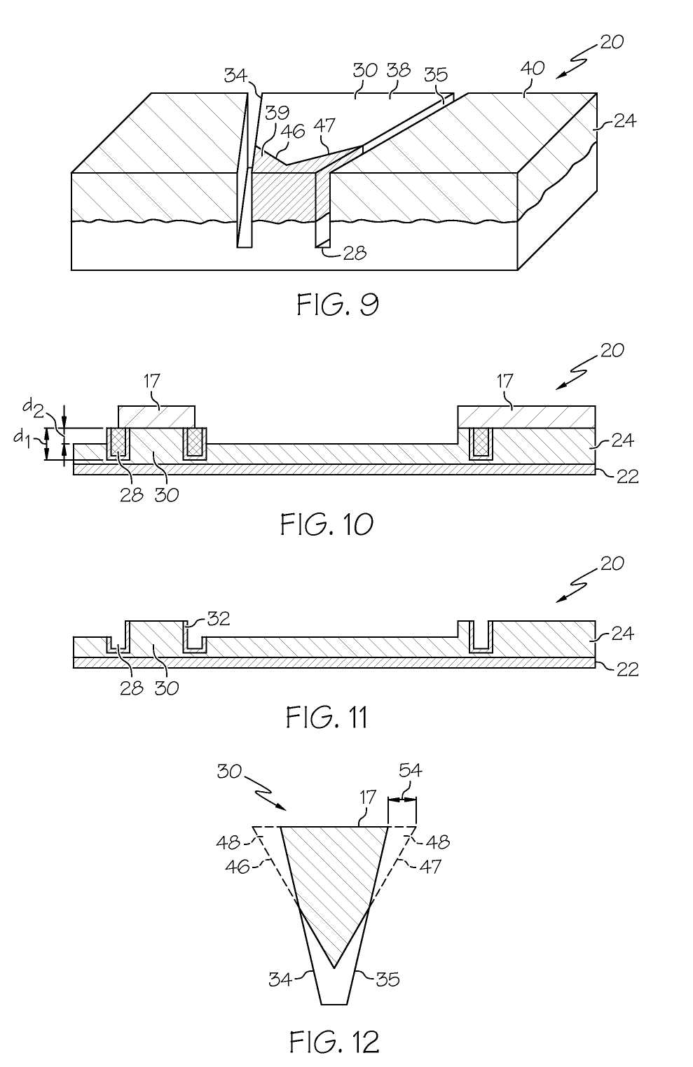

FIG. 9 shows a three-dimensional view of a silicon wafer 20 having a mesa 30. Material that will be removed during the second patterning step is shaded. Please note that filler 44 material is not shown in the trenches 28 of FIG. 9 to better illustrate the second patterning step. A non-shaded portion 38 of the mesa 30 will be protected by the second photoresist layer 17 (see FIG. 8). A shaded portion 39 of the mesa 30 indicated material that will be removed by the second patterning step.

In some embodiments, the second patterning step removes material 40 from the top silicon layer 24 that does not necessarily comprise a mesa 30. Thus, the second patterning step can remove non-mesa material.

FIG. 10 shows a silicon wafer 20 after material of the top silicon layer 24 has been removed by the second patterning step. Desirably, the second patterning step removes material to a lesser depth than the first patterning step. For example, the depth d₁ of a trench 28 formed by the first patterning step is greater than a depth d₂ of material removed by the second patterning step.

FIG. 11 shows the silicon wafer 20 after the second photoresist 17 and any filler material 44 has been removed.

In some embodiments, the filler 44 remains in the trench 28 and is not removed. In some embodiments, the filler 44 is removed. When the filler 44 comprises an oxide or a poly-silicon, it can be removed by corrosion, such as a hydrofluoric acid dip. When the filler 44 comprises an anti-reflective coating (e.g. hydrocarbons), it can be removed using organic solvents.

In some embodiments, if an optical isolation layer 32 was used, it will remain on the silicon wafer 20 after completion of the second patterning process and subsequent cleaning. In some embodiments, the optical isolation layer 32 can be removed, for example being removed along with the second photoresist 17.

FIG. 12 shows a top view of an example of a mesa 30, and illustrates a cross-defined lithography/patterning achieved on the mesa 30 during the first and second patterning steps. A first sidewall 34 and second sidewall 35 of the mesa 30 are shown in FIG. 12, which can be similar to sidewalls 34, 35 shown in FIG. 9. Thus, the sidewalls 34, 35 of the mesa 30 can be formed by patterning trenches 28 during the first patterning step.

An example of a second photoresist 17 used during the second patterning step is also shown in FIG. 12. In some embodiments, a portion of the second photoresist 17 that is located on a mesa 30 includes a first boundary line 46 and a second boundary line 47. Desirably, the first boundary line 46 is non-parallel to the first sidewall 34 of the mesa 30, and the second boundary line 47 is non-parallel to the second sidewall 35 of the mesa 30. Thus, the masking and etching of the first patterning step can be considered cross-defined when compared to the masking and etching of the second patterning step. The resulting shaped mesa 30 has been defined by the overlap of the patterning processes.

In some embodiments, an angle between the first boundary line 46 and the first sidewall 34 of the mesa 30 is equal to an angle between the second boundary line 47 and the second sidewall 35 of the mesa 30. In some embodiments, the mesa 30 is symmetrical across its width.

In some embodiments, the second masking pattern includes one or more trench overlapping portions 48 that are positioned over a trench 28 that was formed by the first patterning step. In some embodiments, desirably, an overhanging width 54 of the trench overlapping portion 48 is less than the width of the trench 28 located beneath the overhanging width 54.

The cross-defined patterning process solves alignment problems that have presented difficulty with prior multiple patterning processes. Because the leading-in portion of the mesa 30 is formed by the second patterning process, and not a combination of patterning processes, the specific alignment of the second patterning step with respect to the first patterning step is less critical. Further, the triangular shapes and symmetry of the overlapping patterns shown in FIG. 12 provide for easier alignment between the two patterning steps.

FIG. 13 shows an embodiment of a silicon wafer 20 after the second patterning step, wherein the resulting mesa 30 comprises a tapered leading-in portion 50 having a first side portion 51 and a second side portion 52. In some embodiments, the mesa 30 comprises the ridge 31 of an optical ridge waveguide 10.

Subsequent to the second patterning step, the surfaces of the mesa 30 may be rough. In some embodiments, one or more smoothing procedures can be performed. In some embodiments, smoothing comprises forming oxidation on the mesa 30, for example by thermal oxidation or vapor deposition, and then stripping off the oxidation, for example using an HF dip.

In some embodiments, a smoothing procedure can reduce an initial width dimension of the mesa 30. In some embodiments, one or more oxidation and strip-off steps can be performed for the purpose of reducing an initial width dimension of the mesa 30.

FIG. 14 shows a top view of a mesa 30, and a coating layer 56 of oxidation.

FIG. 15 shows the mesa 30 of FIG. 14 after the coating layer 56 of oxidation has been removed. The oxide and strip-off steps have reduced an initial width dimension 60 of the mesa 30.

In some embodiments, one or more additional coating layer(s) 58 are added on the top silicon layer 24. Desirably, an additional coating layer 58 comprises a material having an index of refraction less than the top silicon layer 24. In some embodiments, an additional coating layer 58 comprises silicon dioxide, silicon nitride, or the like.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A method of making an optical waveguide comprising:
providing a silicon wafer;
patterning a surface of said silicon wafer to remove a first portion of material to a first predetermined depth according to a first masking pattern, thus forming trenches and defining a silicon mesa between the trenches;
filling said trenches with a filler and planarizing the surface of the silicon wafer;
patterning a surface of said silicon mesa to remove a second portion of material to a second predetermined depth according to a second masking pattern.

2. The method of claim 1, wherein said trenches are filled such that said filler occupies an entire cross-sectional area of each trench and a top surface of said filler is at least as high as a top surface of said mesa prior to said planarization.

3. The method of claim 1, wherein said patterning a surface of said silicon mesa to remove a second portion of material further comprises removing silicon from a non-mesa portion of said silicon wafer.

4. The method of claim 1, wherein said second predetermined depth is less than said first predetermined depth.

5. The method of claim 1, wherein said filler comprises an anti-reflective coating, a poly-silicon or an oxide

6. The method of claim 5, further comprising removing said filler.

7. The method of claim 1, wherein said first masking pattern comprises a different shape than said second masking pattern.

8. The method of claim 1, wherein said first masking pattern overlaps said second masking pattern used in patterning said surface of said silicon mesa.

9. The method of claim 8, wherein the first masking pattern defines a first edge and the second masking pattern defined a second edge, the first edge non-parallel to the second edge.

10. The method of claim 9, wherein said first edge of said first masking pattern defines an edge of said silicon mesa, and said second edge of said second masking pattern defines a tapered initial portion of said silicon mesa.

11. The method of claim 1, wherein said planarizing comprises a chemical mechanical planarization.

12. The method of claim 1, wherein said planarizing comprises an etch-back.

13. The method of claim 1, further comprising another planarizing step.

14. The method of claim 13, wherein said another planarizing step is performed before any of said patterning.

15. The method of claim 1, further comprising applying an optical isolation layer to at least one surface of said silicon wafer.

16. The method of claim 15, wherein said optical isolation layer is applied to a surface of a trench prior to said filling.

17. The method of claim 1, further comprising oxidizing and de-oxidizing said silicon mesa.

18. The method of claim 1, further comprising applying a covering to said silicon wafer subsequent to said patterning a surface of said silicon mesa.

19. The method of claim 18, wherein said covering comprises silicon dioxide or silicon nitride.

20. A method of making an optical waveguide comprising:
providing a silicon wafer;
patterning a top surface of said silicon wafer to remove a first portion of material to a first predetermined depth; and
patterning a remaining portion of said top surface to remove a second portion of material to a second predetermined depth, wherein the first predetermined depth is deeper than the second predetermined depth.
